(19) United States
(12) Patent Application Publication
(10) Pub. No.: US 2004/0058778 A1
(43) Pub. Date: Mar. 25, 2004

(54) Low speed manoeuvring control

(76) Inventors: Robert Stanley Wheeler, Preston (GB); Alfred John Richardson, Cheshire (GB); Martin Fowler, Lymm Cheshire Wa (GB); Keith Wright, Lancashire (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/333,164

(22) PCT Filed: Jul. 24, 2001
(86) PCT No.: PCT/IB01/01321

(30) Foreign Application Priority Data
Jul. 26, 2000 (GB) 0018187.5

(51) Int. Cl. B60K 41/28

(52) U.S. Cl. 477/71

(57) ABSTRACT

When a vehicle is operating in launch or manoeuvring modes, the vehicle can be controlled by operation of the brake alone; the engagement of the friction clutch is in inverse proportion to the amount of braking effort demanded by the operator.

This invention relates to improvements in vehicle clutch operation, in particular in the low speed manoeuvring phase.

It is well known that when manoeuvring a vehicle at low speed the driver is normally concentrating on positioning the vehicle and the control of vehicle speed needs to be simplified as much as possible. This is particularly true in commercial vehicles where visibility may be restricted. For vehicles with conventional clutches the driver will have to control the clutch and throttle pedal together.

When driving a vehicle fitted with a torque converter transmission the operation of the transmission is characterised by the slip and torque multiplication available from the torque converter section. The “feel” of the transmission is recognisable by an “urge to move” when the vehicle is stationary. This urge to move is caused by the “stall torque” of the torque converter at engine idle speed. Under certain conditions the vehicle will “creep” or move slowly forward when the driver takes his foot off the brake pedal. Under other conditions, such as those when the vehicle is pointing up a hill and a forward gear is selected, it can prevent the vehicle moving backward and when the vehicle is stationary and the driver moves his foot from the brake to the accelerator pedal. This movement is not consistent and will vary depending on gradient and vehicle weight. For example when the vehicle is facing up a gradient the slip may not be sufficient to move the vehicle but may just prevent it rolling backward. This creep can be useful for low speed manoeuvring, the driver can allow the vehicle to slowly move backward and forward without pressing the throttle pedal, achieving movement just with control of the brake.

An Automated Mechanical Transmission (AMT) controls the selection of gear and may control the operation of the clutch. An AMT is normally connected to a friction clutch. Often, the driver has only two pedals in the cab, an accelerator or throttle control and a brake. Normal control of the clutch is provided by the Central Processing Unit (CPU) of the AMT, which does not present the driver with an “urge to move” feeling. When stationary there is nothing to prevent a vehicle fitted with an AMT rolling forwards or backwards when the

driver moves his foot from the brake pedal to the accelerator pedal. There is no “creep” feel as is commonly found in known fully automatic transmissions fitted with a torque converter. To present a sensation more like a known hydraulic torque converter type of automatic transmission to an AMT it is possible to allow the clutch to slip slightly under zero speed conditions. This replicates the effect of the torque converter and is more normal for a driver because it more closely resembles the effect felt with a torque converter type transmission.

Current implementations of automated clutch systems control engagement of the clutch depending on primarily the driver demand measured at the accelerator pedal. The further the accelerator is depressed the faster the clutch is engaged and the faster the vehicle accelerates. This system works well for normal starting but for low speed manoeuvring is not very satisfactory, because the throttle is too sensitive when the accelerator is depressed fully. This means a method is required to notify the system that the driver is manoeuvring and not requiring a normal start. In current implementations this takes the form of a manoeuvring mode switch or a restriction in certain low gears.

According to the present invention there is provided a vehicular clutch system installable between a prime mover and a multiple ratio change gear transmission system, the clutch being changeable from a disengaged to engaged positions, and being capable of transmitting torque from the prime mover to the transmission in response to command signals from a clutch operator, signal processing means receiving: i) input signals from a vehicle braking system indicative of the amount of braking effort being demanded, and ii) signals indicative if whether the vehicle is in launch or maneuvering modes, said signal processing means providing output command signals to the clutch operator to command the engagement of said clutch in an inverse relationship to the amount of braking effort being demanded when said vehicle is in launch or manoeuvering mode.

It is found to be particularly advantageous to allow a certain amount of clutch slip to occur to enable the vehicle to be moved slowly and so make it easier to control the vehicle when undertaking precision manoeuvring at slow speeds in confined spaces.

The invention will now be described in greater detail with reference to the accompanying drawings in which:

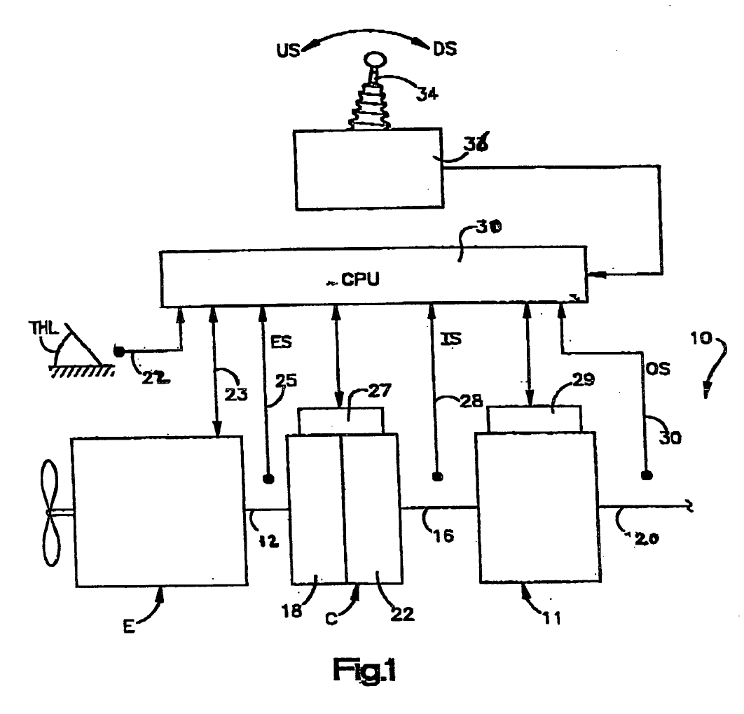

FIG. 1 shows a general arrangement of a transmission system fitted to a vehicle and operable according to the present invention and

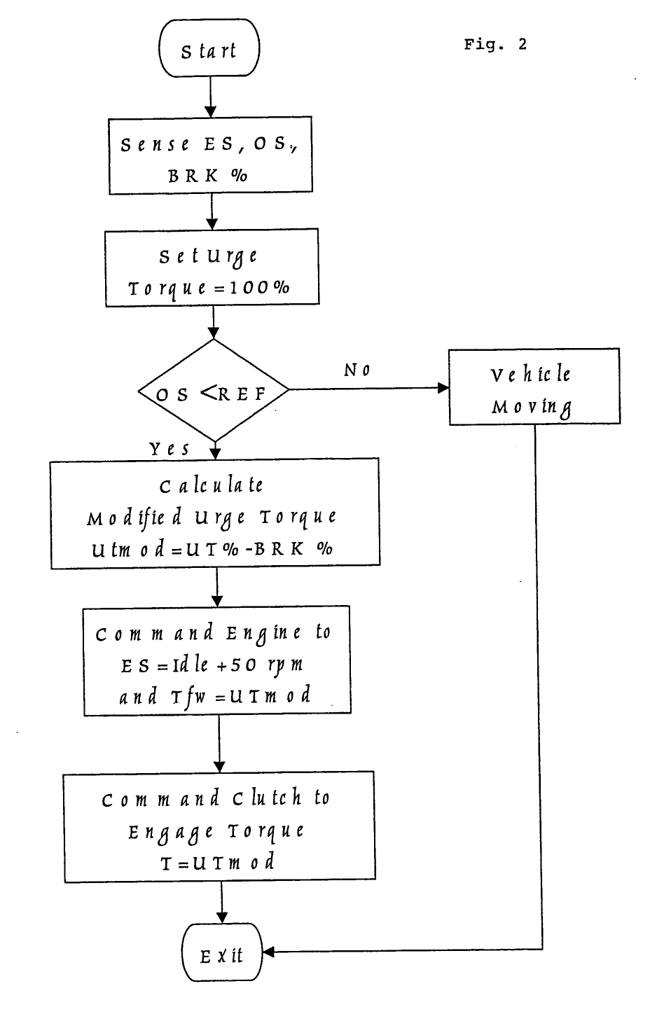

FIG. 2 shows a flow chart of the control system of the present invention.

FIG. 1 shows a transmission system 10 including an engine E having an output shaft 12 connected to a clutch C, which is in turn connectable to an input shaft 16 of a change gear transmission 11. The transmission 11 has an output shaft 20 connected to the drive wheels (not shown) of the vehicle.

The system is controlled by a CPU 30, which preferably is a single signal processing unit, but alternatively could be a plurality of distributed processing units. In such circumstances the processing units may be located on the transmission, in the vehicle cab, on the engine, on the chassis or any combination of these. The transmission will normally have a number of modes in which it can operate, including manual and automatic. There may be additional functions to enable the shift points to be adjusted to suit the prevailing conditions.

The engine power demanded by a driver is signaled by THL 22, whose output signal is sent to the engine E along link 23 and also to the CPU 30. The driver will also be provided with a gear ratio selector lever 34, usable to select a transmission ratio or to override the selection made by the CPU if the transmission is in automatic mode. Operation of the clutch C is controlled by the CPU, whose control signals are sent to a clutch operator 27. Operation of the transmission will be by known means not forming a part of this invention. The gear ratio selector lever 34 operates a set of contacts in unit 36 to provide an output signal to the CPU 30. The selector lever 34 is used by the driver to select a gear ratio or to override the ratio selected by the transmission. Additional inputs to the CPU are from sensors ES, IS and OS which measure engine speed, transmission inputs shaft speed and transmission output shaft speed respectively. Output shaft speed can be used to determine vehicle speed in known manner.

The CPU will receive inputs of signals of ES, IS and OS from the appropriate sensors. The transmission controller 29 will also supply information about the currently engaged gear ratio (GR).

The CPU 30 will receive inputs from ES, OS and a measure of the brake effort being demanded BE. The value of BE may be supplied as a percentage of total brake effort available and read from the CAN bus data system if such a system is fitted to the vehicle, or it could be determined from a brake position sensor.

Operation of the manoeuvre mode can be implemented in a number of ways. In one method the driver can be provided with a switch on the vehicle fascia or on the gear selector mechanism. The switch can be turned to indicate a manoeuvring mode is desired and enable the various control units to react appropriately.

An alternative method of implementation is to automatically enable the manoeuvring mode only when reverse or 1^{st} or 2^{nd} gears are engaged.

Urge Torque in this specification is the amount of torque required to make the vehicle feel as if it is ready to move off from rest. It is an empirically determined figure that will depend on the weight and type of vehicle. It can be qualitatively described as the amount of torque needed to provide the driver with the sensation that at least any slack in the drive-line has been partially taken up and the clutch engagement process has started and so the vehicle is ready to move off.

The value of Urge Torque will be higher than engine idle torque, whose net value will be zero at engine idle speed. It will therefore be necessary to increase the engine output to provide the Urge Torque.

To control the engine torque at low speeds it is normally necessary to take control of the engine from the engine idle speed controller or function incorporated in the engine ECU. By lifting the engine speed say 50 rpm above idle the transmission CPU takes control of the operation of both clutch and throttle and so is able to adjust engine torque to meet the pre-determined requirements.

FIG. 2 shows a flow chart which starts with assumption the vehicle is in manouvre mode. The CPU then senses Engine Speed ES, Output shaft speed OS, and the level of brake effort demanded BE. If engine speed is at idle the CPU then commands the engine to supply the Urge Torque, UT. The transmission output shaft speed OS, can be used to provide an indication of the vehicle speed and if it is less than a pre-determined value, the routine continues. If the test determines the vehicle is moving, it then exits the routine.

Assuming the routine continues, the next step is to determine if the vehicle speed is less than a predetermined amount. If the vehicle speed is found to be above a predetermined reference value, of say about 16 kph (10 mph) then the vehicle is not considered to be in manoeuvre mode. Preferably if the vehicle moving the upper speed limit (OS<REF) speed should be 5-10 kph. Above those speeds the system should seek to engage the clutch fully and move into a different mode.

If the vehicle speed is less than the pre-determined reference speed a modified value of Urge Torque is then calculated, modified in response to the amount of Brake Effort BE demanded. The amount of Urge Torque required is:

UT_{MOD}=UT%/−BE%

The engine is then commanded to provide the modified level of Urge Torque as explained above. The clutch operator is then commanded to engage so as to transmit torque in an inverse relationship to the amount of brake effort demanded.

By measuring the braking effort, the clutch call be controlled to vary the amount and torque transmitted to the wheels and hence the slip. With the brake completely disengaged the amount of slip can be calculated to allow the vehicle to move forward at a low speed of say 5-10 kph depending upon such as factors vehicle gearing, gear ratio selected, vehicle weight, engine idle speed, etc. As the brake effort demanded increases the amount of torque transmitted is decreased until the vehicle is stationary and the brake applied sufficiently to prevent the vehicle rolling. At that stage the clutch will be completely disengaged so there will be no slipping of the clutch. This controlled slip makes easier manoeuvring and better vehicle control possible.

The level of Urge Torque transmitted by the clutch is an inverse relationship to the amount of brake effort demanded. Thus the harder the brake pedal is pushed, the less the amount of torque is transmitted by the clutch to the drive wheels.

From a stopped position if a low gear ratio is selected and the driver is pressing firmly on the brake pedal, demanding say 100% brake effort, no movement of the vehicle will occur. As the brake pedal is released the clutch will start to enter a slipping engagement. The inverse relationship between brake effort demanded and clutch engagement will result in the clutch slipping and transmitting torque to the drive wheels. As the amount of urge torque transmitted increases, a point will be reached at which the friction forces in the drive-line, which includes friction arising from the brakes due to applied pressure will be less than the modified Urge Torque and so the vehicle will move off.

Once the brake pedal is fully released the clutch torque transmitted will become the maximum urge torque, but it is not normally sufficient for synchronous engagement. Synchronous (non-slipping) engagement will normally only occur on a downhill start.

By modifying the amount of torque transmitted by the clutch in response to the level of brake effort demanded it is possible to reduce the clutch wear and so prolong its life.

In referring to a friction clutch it should be understood that the term friction clutch could mean a single or multiple plate wet dry clutch. (In a wet clutch oil is circulated around the region of the friction plates.)

In general it will be appropriate to limit the speeds to a low target speed level, say about 5-10 kph but they could be as high as 16 kph (approx 10 mph). It may also be desirable to have different maximum speeds forward and reverse.

1. A vehicular clutch system installable between a prime mover and a multiple ratio change gear transmission system, the clutch being changeable from a disengaged to engaged positions, and being capable of transmitting torque from the prime mover to the transmission in response to command signals from a clutch operator, signal processing means receiving:
i) input signals from a vehicle braking system indicative of the amount of braking effort being demanded, and
ii) signals indicative if whether the vehicle is in launch or maneuvering modes,
said signal processing means providing output command signals to the clutch operator to command the engagement of said clutch in an inverse relationship to the amount of braking effort being demanded when said vehicle is in manoeuvering mode.

2. A clutch system according to claim 1 in which the maneuvering mode is only available in any one of the lowest three forward gear ratios and reverse gears in

3. A clutch system according to any of claims 1 or 2 in which the maneuvering mode is selected by a dedicated selector means.

4. A clutch system according to any preceding claim which the maximum vehicle speed in maneuvering modes is 16 kph.

5. A method of operating a vehicle clutch system installed in a vehicle between a prime mover and a transmission system, the clutch being engageable to transmit torque from the prime mover to the transmission system, means for receiving a signal indicative of the amount of braking effort being demanded, means for receiving signals indicative of whether the vehicle is in maneuvering or launch modes, signal processing means receiving as inputs said braking effort signals and vehicle maneuvering or launch mode signals and processing said inputs to provide an output signal to a clutch operator to command engagement of said clutch in inverse relationship to the amount of braking effort demanded provided the vehicle speed is less than a predetermined maximum.
